(19) United States
(12) Patent Application Publication
(10) Pub. No.: US 2025/0105275 A1
(43) Pub. Date: Mar. 27, 2025

(54) POSITIVE ELECTRODE CONTAINING POSITIVE ELECTRODE ACTIVE MATERIAL HAVING MULTIMODAL PARTICLE-SIZE DISTRIBUTION AND ALL-SOLID-STATE BATTERY INCLUDING THE SAME

(71) Applicant: KOREA ELECTRONICS TECHNOLOGY INSTITUTE, Seongnam-si (KR)

(72) Inventors: Woo Suk CHO, Seongnam-si (KR); Hyun Seung KIM, Seoul (KR); Jun Ho SONG, Seongnam-si (KR); Ji Sang YU, Seongnam-si (KR); Kyung Su KIM, Yongin-si (KR)

(21) Appl. No.: 18/823,190

(22) Filed: Sep. 3, 2024

(30) Foreign Application Priority Data
Sep. 21, 2023 (KR) 10-2023-0126169

(51) Int. Cl. H01M 4/525; C01G 53/00; H01M 4/02; H01M 4/131; H01M 4/62; H01M 10/0585

(52) U.S. Cl. CPC H01M 4/525; C01G 53/50; H01M 4/131; H01M 4/62; H01M 10/0585; C01P 2002/50; C01P 2004/03; C01P 2004/50; C01P 2004/51; C01P 2006/40; H01M 2004/028

(57) ABSTRACT

Proposed is a positive electrode containing a positive electrode active material having a multimodal particle-size distribution to suppress particle crack of the positive electrode active material caused by pressure applied during a positive electrode and cell manufacturing process, thereby exhibiting excellent electrical characteristics. In addition, an all-solid-state battery including the positive electrode is proposed. The positive electrode may include a positive electrode active material formed of a lithium transition metal oxide and having a multimodal particle-size distribution in which particles with relatively small particle diameters have greater particle strength than particles with relatively large particle diameters.

### CROSS REFERENCE TO RELATED APPLICATION

The present application claims priority to Korean Patent Application No. 10-2023-0126169 Sep. 21, 2023, the entire contents of which are incorporated herein for all purposes by this reference.

### BACKGROUND

### Technical Field

The present disclosure relates to an all-solid-state battery. In particular, the present disclosure relates to a positive electrode containing a positive electrode active material having a multimodal particle-size distribution that suppresses particle crack of the positive electrode active material caused by pressure applied during a positive electrode and cell manufacturing process, thereby exhibiting excellent electrical characteristics, and also relates to an all-solid-state battery including that positive electrode.

### Description of Related Technology

All-solid-state batteries are those that replace a flammable organic liquid electrolyte typically used in lithium secondary batteries with a non-flammable (or flame-retardant) solid electrolyte. Such all-solid-state batteries are attracting attention as they are expected to have improved safety and higher energy density through the application of new electrode materials. The all-solid-state battery uses the same positive and negative electrode active materials as the lithium secondary battery, but differs in that the separator and electrolyte are replaced with a solid electrolyte layer.

### SUMMARY

One aspect is a positive electrode containing a positive electrode active material having a multimodal particle-size distribution for realizing a high mixture density of the positive electrode, and an all-solid-state battery including the same.

Another aspect is a positive electrode containing a positive electrode active material having a multimodal particle-size distribution for suppressing particle crack of the positive electrode active material caused by pressure applied during a positive electrode and cell manufacturing process, thereby exhibiting excellent electrical characteristics, and an all-solid-state battery including the same.

Another aspect is a positive electrode containing a positive electrode active material having a multimodal particle-size distribution for improving the battery life characteristics, and an all-solid-state battery including the same.

Another aspect is a positive electrode for an all-solid-state battery. The positive electrode includes a positive electrode active material formed of a lithium transition metal oxide and having a multimodal particle-size distribution in which particles with relatively small particle diameters have greater particle strength than particles with relatively large particle diameters.

The positive electrode active material may have the multimodal particle-size distribution with different average particle diameters of D₅₀ values.

The positive electrode active material may have the multimodal particle-size distribution in which there are a large-particle positive electrode active material (A) and a small-particle positive electrode active material (B) having different average particle diameters of D₅₀ values.

A particle strength ratio may be dB/dA≥2, where dA is the particle strength of the large-particle positive electrode active material, and dB is the particle strength of the small-particle positive electrode active material.

A particle diameter ratio of the large-particle positive electrode active material to the small-particle positive electrode active material may be rA/rB≥2, where rA is the particle diameter of the large-particle positive electrode active material, and rB is the particle diameter of the small-particle positive electrode active material.

Each SPAN value of the large-particle positive electrode active material and the small-particle positive electrode active material may be (D₉₀−D₁₀)/D₅₀<1.

The small-particle positive electrode active material may have a particle strength of 300 to 1500 MPa.

A weight ratio of the large-particle positive electrode active material to the small-particle positive electrode active material may be 7:3 to 4:6.

The large-particle positive electrode active material may be a secondary particle in which primary particles are aggregated.

The small-particle positive electrode active material may be a single particle or a secondary particle.

The lithium transition metal oxide may be represented by Chemical Formula below:

LiₓM_{y}O₂ Chemical Formula

where M contains Ni and further contains at least one selected from Co, Mn, Al, Fe, V, Zn, Cr, Ti, Ta, Mg, Mo, Zr, W, Sn, Hf, Nd, and Gd, 0<x≤1.5, and 0<y≤1.

The lithium transition metal oxide may include at least one of NCA, NCM and NCMA having a layered structure with a Ni content of 60% or more.

The positive electrode may further include a solid electrolyte, a conductive agent, and a binder.

A weight ratio of the positive electrode active material to the solid electrolyte may be 85% or more.

According to the present disclosure, an all-solid-state battery is provided. The all-solid-state battery includes the above-described positive electrode, a solid electrolyte layer, and a negative electrode.

another aspect is a positive electrode for the all-solid-state battery that includes the positive electrode active material having a multimodal particle-size distribution and also having particle strength inversely proportional to the particle diameter, so that it is possible to suppress particle crack of the positive electrode active material caused by pressure applied during a process of manufacturing the positive electrode and cell of the all-solid-state battery. That is, in the case of manufacturing the positive electrode to contain the positive electrode active material having a multimodal particle-size distribution, a space between large particles is filled with relatively small particles. Therefore, the porosity inside the positive electrode can be reduced even when no pressure is applied. In addition, since small particles have higher particle strength than large particles, the pressure applied to the large particles during the pressurizing process is absorbed by the small particles. This makes it possible to suppress particle cracks of the positive electrode active material caused by pressure applied during a process of manufacturing the positive electrode and the cell of the all-solid-state battery. In addition, it is possible to utilize large particles with relatively low particle strength for the positive electrode active material.

Therefore, the positive electrode for the-solid-state battery according to the present disclosure can improve the life characteristics of the all-solid-state battery because it implements a high mixture density and exhibits excellent electrical characteristics.

In order to suppress the particle crack of the positive electrode active material due to the pressurization process, typical positive electrodes for the all-solid-state battery had to use a positive electrode active material with high particle strength or maintain a certain content of a binder or solid electrolyte. However, there is a limit to increasing the particle strength of the positive electrode active material. In addition, when the content of the binder or solid electrolyte is high, the content of the positive electrode active material in the positive electrode relatively decreases, which causes a problem in that the capacity of the all-solid-state battery decreases.

However, the positive electrode for the all-solid-state battery according to the present disclosure that uses the positive electrode active material having a multimodal particle-size distribution can implement a high-capacity all-solid-state battery by maintaining the content of the positive electrode active material in the positive electrode at 85 wt % or more.

### BRIEF DESCRIPTION OF THE DRAWINGS

FIG. 1 is a cross-sectional view showing an all-solid-state battery according to the present disclosure.

FIG. 2 is an enlarged view of part A of the positive electrode shown in FIG. 1.

FIG. 3 is a SEM image showing a positive electrode active material having a large particle diameter used in the manufacture of positive electrodes according to an embodiment and a comparative example.

FIG. 4 is a SEM image showing a positive electrode active material having a small particle diameter used in the manufacture of positive electrodes according to an embodiment and a comparative example.

FIG. 5 is a graph showing a change in packing density of a positive electrode active material depending on pressurization conditions in the manufacture of positive electrodes according to an embodiment and comparative examples.

FIG. 6 is a SEM image showing a cross-section of a positive electrode manufactured after a pressurization process according to a first comparative example.

FIG. 7 is a SEM image showing a cross-section of a positive electrode manufactured after a pressurization process according to an embodiment.

FIG. 8 is a drawing showing a uniaxial pressure cell used for evaluating an all-solid-state battery containing a positive electrode manufactured according to each of an embodiment and a comparative example.

FIG. 9 is a graph showing the results of life characteristic evaluation of all-solid-state batteries according to an embodiment and a first comparative example.

FIG. 10 is an SEM image showing the cross-section of a positive electrode according to a first comparative example after the life characteristic evaluation of FIG. 9.

FIG. 11 is an SEM image showing the cross-section of a positive electrode according to an embodiment after the life characteristic evaluation of FIG. 9.

### DETAILED DESCRIPTION

In an all-solid-state battery, the positive electrode in which the positive electrode active material and the solid electrolyte are mixed at a certain ratio is implemented in contact with the solid electrolyte layer in order to form a smooth ion conduction channel within the positive electrode.

Since the lithium secondary battery uses a liquid electrolyte, the electrolyte permeates smoothly into the particles of the positive electrode active material. As a result, in the lithium secondary battery, contact between the positive electrode active material and the electrolyte for forming a smooth ion conduction channel is evenly made on the surface and inside of the particles of the positive electrode active material.

However, since the positive electrode of the all-solid-state battery forms an ion conduction channel by surface contact between the positive electrode active material and the solid electrolyte, the solid electrolyte cannot permeate into the interior of the positive electrode active material particles. In other words, an ion conduction channel is formed between the positive electrode active material and the solid electrolyte only through particle surface contact, and thus if the contact area between the positive electrode active material and the solid electrolyte is not sufficiently secured, there is a disadvantage in that it acts as resistance and the degree of capacity implementation is reduced.

In manufacturing the positive electrode of the all-solid-state battery, in order to ensure smooth interfacial contact between the positive electrode active material and the solid electrolyte, a process is needed to manufacture a dense electrode without internal pores, that is, an electrode with a high packing density (same meaning as mixture density). The dense electrode means having a high electrode mixture (g/cm³), and can be a way to increase the energy density per volume (Wh/L). Therefore, a process for pressurizing and molding the electrode at high pressure is essential.

However, in the pressurization process, a phenomenon of particle destruction (crack) in which the positive electrode active material is broken may occur. If cracks occur in the positive electrode active material, the performance of the positive electrode deteriorates, such as the occurrence of an inactive death zone where the ion conductive path is lost or a decrease in long-life characteristics. Therefore, a solution to this problem is needed.

Now, embodiments of the present disclosure will be described in detail with reference to the accompanying drawings. However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

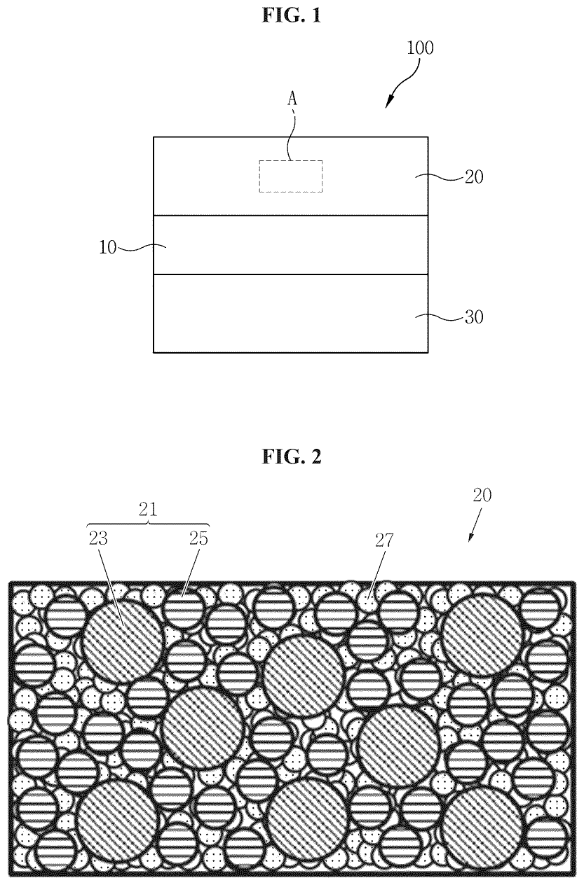

FIG. 1 is a cross-sectional view showing an all-solid-state battery according to the present disclosure. FIG. 2 is an enlarged view of part A of the positive electrode shown in FIG. 1.

Referring to FIGS. 1 and 2, the all-solid-state battery 100 according to the present disclosure includes a solid electrolyte layer 10 and also includes a positive electrode 20 and a negative electrode 30 which are respectively formed to be in contact with both sides of the solid electrolyte layer 10.

The solid electrolyte layer 10 includes one of a sulfide-based solid electrolyte, oxide-based solid electrolyte, and chloride-based solid electrolyte.

Here, the sulfide-based solid electrolyte may be LₐM_{b}P_{c}S_{d}Xₑ (Here, L is alkali metal and M is at least one of B, Al, Ga, In, Si, Ge, Sn, Pb, As, Sb, Bi, Ti, V, Cr, Mn, Fe, Co, Ni, Cu, Y, Zr, Nb, Mo, Tc, Ru, Rh, Pd, Ag, Hf, Ta, and W. X is at least one of F, Cl, Br, I, and O. 0≤a≤12, 0≤b≤6, 0≤c≤6, 0≤d≤12, 0≤e≤9). Alternatively, the sulfide-based solid electrolyte may be a plurality of crystalline solid electrolytes, a plurality of amorphous sulfide-based solid electrolytes, or a mixture thereof. For example, the sulfide-based solid electrolyte may be Li₆PS₅Cl (LPSCl), Li₁₀GeP₂S₁₂ (LGPS), Li₂S—P₂S₅ (LPS), or the like.

The oxide-based solid electrolyte may be Li₃ₓLa_{2/3-x}TiO₃ (LLTO), Li₇La₃Zr₂O₁₂ (LLZO), or the like.

The chloride-based solid electrolyte may be Li₃YCl₆, Li₃YBr₆, or the like.

The positive electrode 20 contains a positive electrode active material 21. In addition, the positive electrode 20 contains a solid electrolyte 27, a conductive agent, and a binder. For the simplicity of illustration, the conductive agent and the binder of the positive electrode 20 are not shown in FIG. 2.

The positive electrode active material 21 is a material that allows inserting and de-inserting lithium ions. The positive electrode active material 21 includes a lithium transition metal oxide used in a lithium secondary battery.

The positive electrode active material 21 according to the present disclosure includes a lithium transition metal oxide containing nickel (Ni) and can be represented by Chemical Formula 1 below.

LiₓM_{y}O₂ [Chemical Formula 1]

(M contains Ni and further contains at least one selected from Co, Mn, Al, Fe, V, Zn, Cr, Ti, Ta, Mg, Mo, Zr, W, Sn, Hf, Nd, and Gd. 0<x≤1.5, 0<y≤1)

The positive electrode active material 21 may include at least one of NCA, NCM and NCMA having a layered structure with a Ni content of 60% or more. For example, the positive electrode active material 21 may be a nickel-rich layered small-particle-diameter lithium metal compound including nickel (Ni), manganese (Mn) and cobalt (Co). This lithium transition metal oxide is expressed as LiNiₐCo_{b}Mn_{c}O₂ (0.6≤a≤0.9, a+b+c=1) and is called a nickel-rich NCM positive electrode active material.

The positive electrode active material 21 has a multimodal particle-size distribution in which particles with relatively small particle diameters have greater particle strength than particles with relatively large particle diameters.

The reason for using the positive electrode active material 21 having a multimodal particle-size distribution in the positive electrode 20 is to increase the packing density of the positive electrode 20. That is, since a space between large particles is filled with small particles, the packing density of the positive electrode 20 can be increased by using the positive electrode active material 21 having various particle sizes.

Not only the positive electrode active material 21 has a multimodal particle-size distribution, but also particles of the positive electrode active material 21 have particle strength inversely proportional to the particle diameter, so that it is possible to suppress particle crack of the positive electrode active material 21 caused by pressure applied during a process of manufacturing the positive electrode 20 and cell of the all-solid-state battery 100.

If particles with different particle diameters have the same particle strength, particles with smaller particle diameters are cracked first as in Equation 1.

$$σ t = 2.8 P / π D \qquad EQUATION 1$$

$$σ t : Tensile strength ( proportional to particle strength )$$

$$P : Breaking force$$

$$D : Particle diameter$$

Therefore, a particle with a relatively small particle diameter (hereinafter referred to as “small particle”) used in the positive electrode active material 21 having a multimodal particle-size distribution has a higher particle strength than a particle with a relatively large particle diameter (hereinafter referred to as “large particle”).

In the case of manufacturing the positive electrode 20 to contain the positive electrode active material 21 having a multimodal particle-size distribution as such, a space between large particles is filled with relatively small particles. Therefore, the porosity inside the positive electrode 20 can be reduced even when no pressure is applied. In addition, since small particles have higher particle strength than large particles, the pressure applied to the large particles during the pressurizing process is absorbed by the small particles. This makes it possible to suppress particle cracks of the positive electrode active material 21 caused by pressure applied during a process of manufacturing the positive electrode 20 and the cell of the all-solid-state battery 100.

In addition, since the positive electrode 20 according to the present disclosure contains the positive electrode active material 21 having a multimodal particle-size distribution, it is possible to suppress cracks in large particles with relatively low particle strength.

The positive electrode active material 21 according to the present disclosure can have a multimodal (or referred to as bimodal herein) particle-size distribution in which there are a large-particle positive electrode active material 23 and a small-particle positive electrode active material 25.

Here, the positive electrode active material 21 having a multimodal (or bimodal) particle-size distribution has physical characteristics of (1) to (4), as follows.
(1) The particle strength ratio of the small-particle positive electrode active material 25 to the large-particle positive electrode active material 23 is dB/dA ≥2 (where dA is the particle strength of the large-particle positive electrode active material 23, and dB is the particle strength of the small-particle positive electrode active material 25).

In the case where the particle strength ratio is less than 2, the effect of a single particle-size distribution is dominant rather than the effect of the multimodal (or bimodal) particle-size distribution.

The small-particle positive electrode active material 25 may have an average particle diameter of 10 μm or less and a particle strength of 300 to 1500 MPa. Preferably, the small-particle positive electrode active material 25 may have an average particle diameter of 5 μm or less and a particle strength of 500 MPa or more.

The large-particle positive electrode active material 23 is a secondary particle in which primary particles are aggregated. The small-particle positive electrode active material 25 may be a single particle or a secondary particle. For example, the single particle used as the small-particle positive electrode active material 25 may be manufactured by the method for manufacturing a positive electrode active material disclosed in Korean Patent No. 10-2568195.
(2) The particle diameter ratio of the large-particle positive electrode active material 23 to the small-particle positive electrode active material 25 is rA/rB≥2 (where rA is the particle diameter of the large-particle positive electrode active material 23, and rB is the particle diameter of the small-particle positive electrode active material 25). Also, the volume ratio of the large-particle positive electrode active material 23 to the small-particle positive electrode active material 25 is vA/vB≥8 (where vA is the volume of the large-particle positive electrode active material 23, and vB is the volume of the small-particle positive electrode active material 25).

In the case where the particle diameter ratio is less than 2, the effect of a single particle-size distribution is dominant rather than the effect of the multimodal (or bimodal) particle-size distribution.

Also, in the case where the volume ratio is less than 8, the effect of a single particle-size distribution is dominant rather than the effect of the multimodal (or bimodal) particle-size distribution.
(3) Each SPAN value of the large-particle positive electrode active material 23 and the small-particle positive electrode active material 25 is (D₉₀−D₁₀)/D₅₀<1. Here, a SPAN value less than 1 means that each of the large-particle positive electrode active material 23 and the small-particle positive electrode active material 25 has a high uniformity of particle-size distribution.

The SPAN value refers to the width of the particle-size distribution calculated using the values of particle diameters D₁₀, D₅₀, and D₉₀. Since the SPAN value is calculated to be large when the particle sizes are widely distributed, and conversely, it is calculated to be small when the particle sizes are narrowly distributed, the particle-size distribution can be identified through the SPAN value.

In the disclosure, the SPAN value less than 1 indicates a uniform particle-size distribution, so it means that excessively large or excessively small particles are not mixed in. Although the positive electrode active material 21 having the multimodal (or bimodal) particle-size distribution is used, the particle-size distribution of each of the large-particle positive electrode active material 23 and the small-particle positive electrode active material 25 is highly uniform. It is therefore possible to secure the stability of the battery and improve the battery performance, such as suppressing the phenomenon that cracks of the positive electrode active material 21 occurs or expansion of the positive electrode 20 occurs during the charge/discharge process.
(4) The weight ratio of the large-particle positive electrode active material 23 to the small-particle positive electrode active material 25 is 7:3 to 4:6, and preferably, the ratio is around 6:4.

If the weight ratio is out of this range, the effect according to the single particle-size distribution is more dominant than the effect according to the multimodal (or bimodal) particle-size distribution.

Meanwhile, the solid electrolyte 27 contained in the positive electrode 20 may be the same as the solid electrolyte used in the solid electrolyte layer 10.

The conductive agent contained in the positive electrode 20 is not particularly limited as long as it is a conductive material used in a battery. For example, as the conductive agent, conductive carbon such as graphene, carbon nanotubes, Ketjen black, activated carbon, powder-type Super-p carbon, rod-type Denka, or vapor-grown carbon fiber (VGCF) may be used. Also, metal particles with high electrical conductivity and no side reactions may be used as the conductive agent. The conductive agent is not limited to those mentioned above.

The binder contained in the positive electrode 20 may be a polymer compound of a fluorine-based, diene-based, acrylic-based, or silicone-based polymer. For example, the binder may be nitrile butadiene rubber (NBR), polytetrafluoroethylene (PTFE), polyvinylidene fluoride (PVDF), carboxymethyl cellulose (CMC), styrene butadiene rubber (SBR), polyimide, etc.

Meanwhile, the negative electrode 30 contains a negative electrode active material, a solid electrolyte, and a conductive agent. The negative electrode 30 may also contain a binder.

The negative electrode active material may be at least one selected from the group consisting of lithium metal, lithium alloy, lithium metal composite oxide, lithium-containing titanium composite oxide (LTO), and combinations thereof.

The solid electrolyte, conductive agent, and binder used in the negative electrode 30 may be the same as those used in the positive electrode 20, so a description thereof is omitted.

### Embodiment and Comparative Example

In order to confirm the physical and electrochemical characteristics of the positive electrode active material for the all-solid-state battery according to the present disclosure, positive electrodes according to an embodiment and comparative examples were manufactured and all-solid-state batteries including the manufactured positive electrodes were manufactured. Here, a method for manufacturing the positive electrode according to the embodiment is only one example, and the present disclosure is not limited to the manufacturing method according to the embodiment.

The positive electrode active material according to the embodiment has a multimodal (or bimodal) particle-size distribution and includes two positive electrode active materials having different average particle diameters of D₅₀ values measured by particle size analysis (PSA). The two positive electrode active materials are a large-particle positive electrode active material and a small-particle positive electrode active material.

Here, the large-particle positive electrode active material has a composition of LiNi_{0.8}Co_{0.1}Mn_{0.1}02, has an average particle diameter of 10.3 μm of D₅₀ values measured by the PSA, and has a particle strength of 150 MPa.

The small-particle positive electrode active material has a composition of LiNi_{0.8}Co_{0.1}Mn_{0.1}O₂, has an average particle diameter of 4.5 μm of D₅₀ values measured by the PSA, and has a particle strength of 1,300 MPa.

### Measurement of Particle Diameter of Positive Electrode Active Material

The average particle diameters of the positive electrode active material, i.e., the values of D₁₀, D₅₀, and D₉₀, were measured using PSA equipment (Microtrac S3500) that utilizes the laser scattering method. A sample was prepared by dispersing ultrasonically 10 mg of the positive electrode active material in 3 mL of IPA, and the prepared sample was measured using the PSA equipment. The SPAN value was calculated as (D₉₀−D₁₀)/D₅₀. The average particle diameters and the SPAN value are as shown in Table 1.

TABLE 1

| | D₁₀ (μm) | D₅₀ (μm) | D₉₀ (μm) | Span |
|---|---|---|---|---|
| Large-particle positive electrode active | 8.3 | 10.3 | 13.1 | 0.47 |
| material | | | | |
| Small-particle positive electrode active | 3.2 | 4.5 | 6.5 | 0.73 |
| material | | | | |

Meanwhile, since the distribution of the average particle diameters may be inaccurate when observed with a SEM image, the SPAN value measured by the PSA equipment is used to derive a more accurate distribution of the average particle diameters. For large- and small-particle positive electrode active materials, those with a SPAN value of 1 or less are used.

### Measurement of Particle Strength

The particle strength of large- and small-particle positive electrode active materials was derived by repeatedly measuring particles corresponding to the D₅₀ size more than 10 times using micro compression testing (MCT) equipment and calculating the average value.

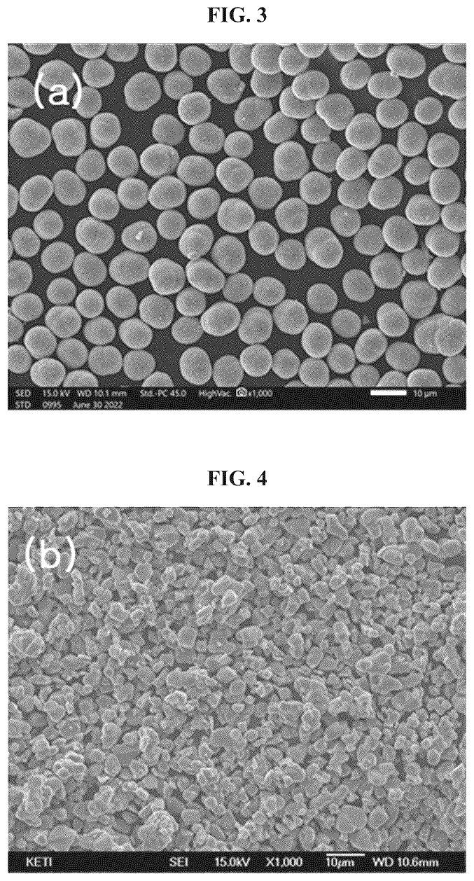

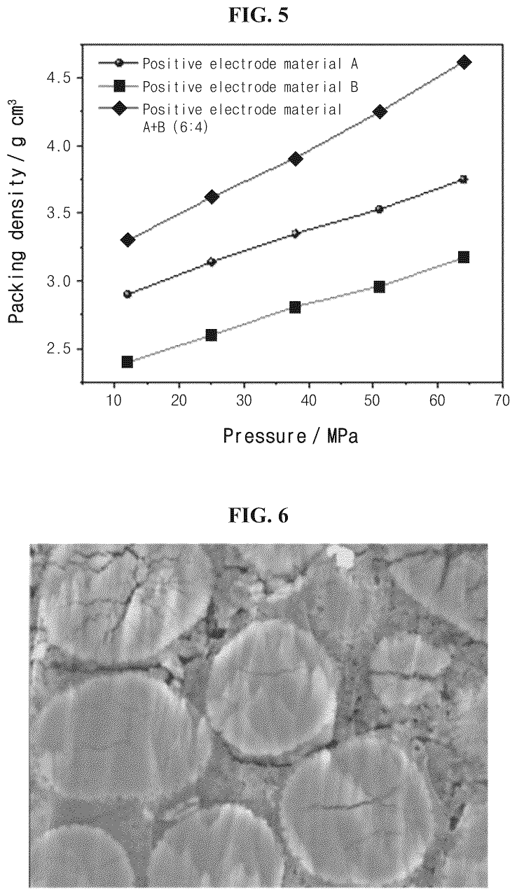

Through the PSA, it was confirmed that the large-particle positive electrode active material had a D₅₀ of 10.3 μm and the small-particle positive electrode active material had a D₅₀ of 4.5 μm. As shown in FIGS. 3 and 4, it was confirmed that the large- and small-particle positive electrode active materials were spherical positive electrode active materials through SEM observation. Here, FIG. 3 is a SEM image showing a positive electrode active material having a large particle diameter used in the manufacture of positive electrodes according to an embodiment and a comparative example. FIG. 4 is a SEM image showing a positive electrode active material having a small particle diameter used in the manufacture of positive electrodes according to an embodiment and a comparative example.

It was confirmed that the large-particle positive electrode active material had a typical shape of positive electrode active material in which primary particles were aggregated to form a spherical secondary particle. Also, it was confirmed that the small-particle positive electrode active material had a shape of single particle. In addition, it was confirmed that the particle diameter ratio rA/rB was 2.29, which is a value greater than 2.

It was confirmed that the particle strength was 150 MPa for the large-particle positive electrode active material and 1300 MPa for the small-particle positive electrode active material, that is, the particle strength was significantly higher in case of the small-particle positive electrode active material compared to the large-particle positive electrode active material. Also, it was confirmed that the particle strength ratio dA/dB was 8.67, which is a value greater than 2.

### Measurement of Packing Density

The packing density for the positive electrode composite (in which the ratio of the positive electrode active material to the solid electrolyte is fixed at 85:15 wt %) was measured in the following manner.

The packing density of the positive electrode composite was measured while the weight ratio of the large-particle positive electrode active material and the small-particle positive electrode active material in the positive electrode composite was changed under a constant pressurization pressure. The measurement results are shown in Table 2 below. Each 40 mg of the positive electrode composite including the positive electrode active material and the solid electrolyte having the composition shown in Table 2 was weighed and placed into a pelletizer having a diameter of 10 mm, and then a pressurization pressure of 437 MPa was applied for 30 seconds to measure the packing density. In Table 2, positive electrode material A represents the large-particle positive electrode active material, and positive electrode material B represents the small-particle positive electrode active material. Li₆PS₅Cl was used as the solid electrolyte.

TABLE 2

Bimodal ratio (wt %)

| Positive electrode | Positive electrode | Packing density |
|---|---|---|
| material A | material B | (g/cm³) |
| 10 | 0 | 2.90 |
| 9 | 1 | 2.85 |
| 8 | 2 | 2.91 |
| 7 | 3 | 2.95 |
| 6 | 4 | 2.96 |
| 5 | 5 | 2.97 |
| 4 | 6 | 2.95 |
| 0 | 10 | 2.79 |

Referring to Table 2, it can be confirmed that when the weight ratio of the large-particle positive electrode active material to the small-particle positive electrode active material is 7:3 to 4:6, the packing density of the positive electrode composite is 2.95 g/cm³ or more. In other words, the packing density of the positive electrode composite increases when the large-particle positive electrode active material and the small-particle positive electrode active material are used together at a weight ratio of 7:3 to 4:6, rather than when used alone.

Next, a change in the packing density of the positive electrode active material was measured while the pressurizing pressure was changed in a state where the weight ratio of the large-particle positive electrode active material and the small-particle positive electrode active material was fixed.

In an embodiment, a positive electrode active material having a bimodal particle-size distribution was prepared by mixing a large-particle positive electrode active material and a small-particle positive electrode active material in a weight ratio of 6:4. In a first comparative example, only the large-particle positive electrode active material was used as the positive electrode active material. In a second comparative example, only the small-particle positive electrode active material was used as the positive electrode active material.

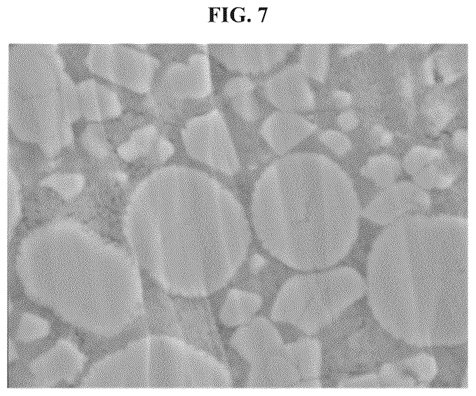

In each of the embodiment, first and second comparative examples, 40 mg of the positive electrode active material was weighed and placed into a pelletizer having a diameter of 10 mm, and the change in packing density according to the applied pressure for 30 seconds was measured. The measurement results are as shown in FIG. 5. FIG. 5 is a graph showing a change in packing density of a positive electrode active material depending on pressurization conditions in the manufacture of positive electrodes according to an embodiment and comparative examples. In FIG. 5, positive electrode material A represents a large-particle positive electrode active material, positive electrode material B represents a small-particle positive electrode active material, and positive electrode material A+B (6:4) represents a positive electrode active material according to an embodiment.

Referring to FIG. 5, it was confirmed that the packing density was higher in the embodiment than in the first and second comparative examples. That is, it was confirmed that it is possible to secure a high packing density through the composite of the large- and small-particle positive electrode active materials having different particle diameter as in the embodiment.

The positive electrode active material according to the embodiment was confirmed to have a packing density of 4.62 under a pressurized condition of 64 MPa. That is, when the theoretical density of NCM811 is assumed to be 4.77, the packing ratio is 96.8%, which means that high-density packing of the positive electrode active material is possible. Therefore, it can be confirmed that the bimodalization of the positive electrode active material with a particle diameter ratio of 2 or more, as in the embodiment, is effective in increasing the packing density of the positive electrode active material.

Based on the positive electrode active material having a bimodal particle-size distribution according to the embodiment, a positive electrode was manufactured and the packing density was measured. That is, the positive electrode active material was prepared while the weight ratio of the large- and small-particle positive electrode active materials was adjusted from 10:0 to 0:10. The prepared positive electrode active material and the sulfide solid electrolyte (Li₆PS₅Cl) was mixed at a weight ratio of 85:15 to prepare a positive electrode composite. 40 mg of this was injected into a pressure cell mold with a diameter of 10 mm and pressurized at 437 MPa for 30 seconds to manufacture a positive electrode. Then, the packing density of the manufactured positive electrode was measured.

As a result of the measurement, among the positive electrode active materials in which the weight ratio of the large- and small-sized positive electrode active materials was adjusted from 10:0 to 0:10, the positive electrode with a weight ratio of 6:4 showed the highest packing density of 2.96 g/cm³.

Comparison of Particle Crack Phenomenon after Manufacture of Positive Electrode

In order to compare the particle crack phenomenon after the manufacture of the positive electrode, positive electrodes according to a first comparative example 1 and an embodiment were manufactured. For each of the positive electrodes according to the first comparative example and the embodiment, a positive electrode composite in which the positive electrode active material and the solid electrolyte (Li₆PS₅Cl) were mixed at a weight ratio of 85:15 was prepared. In the first comparative example 1, only the large-particle positive electrode active material was used as the positive electrode active material. In the embodiment, the positive electrode active material had a bimodal particle-size distribution, and the weight ratio of the large- and small-particle positive electrode active materials was 6:4.

In each of the first comparative example and the embodiment, 40 mg of the positive electrode composite was placed in a pressure cell mold with a diameter of 10 mm and pressurized at 437 MPa for 30 seconds to obtain a positive electrode. Then, the positive electrode was processed with a cross-sectional polisher to prepare a specimen. The prepared specimens according to the first comparative example and the embodiment were measured using SEM, and the measurement results are as shown in FIGS. 6 and 7. FIG. 6 is a SEM image showing a cross-section of a positive electrode manufactured after a pressurization process according to a first comparative example, and FIG. 7 is a SEM image showing a cross-section of a positive electrode manufactured after a pressurization process according to an embodiment. The processing and SEM measurement of the specimen were performed in a dry room (dew point −50° C.) to minimize moisture reaction in the air.

Referring to FIGS. 6 and 7, particle crack of the large-particle positive electrode active material was observed in the first comparative example. On the other hand, particle crack of the large- or small-particle positive electrode active material was not observed in the positive electrode active material having a bimodal particle-size distribution according to the embodiment.

Therefore, it can be confirmed that crack of the positive electrode active material did not occur in the embodiment even after the high pressure process required for the manufacture of the positive electrode. This means that when the small-particle positive electrode active material with high particle strength is mixed, there is an effect of suppressing particle crack of the large-particle positive electrode active material with relatively low particle strength. In other words, it is understood that when the positive electrode is pressurized, the high-strength small-particle positive electrode active material absorbs and disperses the pressure applied to the positive electrode, thereby suppressing particle crack of the large-particle positive electrode active material.

### Life Characteristic Evaluation

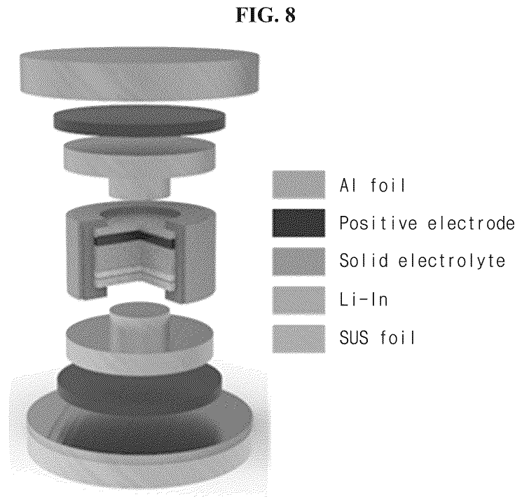

After manufacturing an all-solid-state battery using a positive electrode including a positive electrode active material according to each of the first comparative example and the embodiment, the life characteristic was evaluated. As the all-solid-state battery for life characteristic evaluation, a uniaxial pressure cell, as shown in FIG. 8, which is generally used for evaluating sulfide-based solid electrolytes, was used. FIG. 8 is a drawing showing a uniaxial pressure cell used for evaluating an all-solid-state battery containing a positive electrode manufactured according to each of an embodiment and a comparative example.

Li₆PS₅Cl was used as the solid electrolyte.

No conductive agent and binder were separately added. This is only to check the behavior of the pure positive electrode active material, and the present disclosure is not limited to this. In the actual manufacture of an all-solid-state battery, it is desirable to add a conductive agent and a binder.

In the uniaxial pressure cell, 10 mg of positive electrode, 100 mg of solid electrolyte layer, and Li—In alloy as a negative electrode were used. In addition, aluminum foil was used as a positive electrode collector, and SUS foil was used as a negative electrode collector.

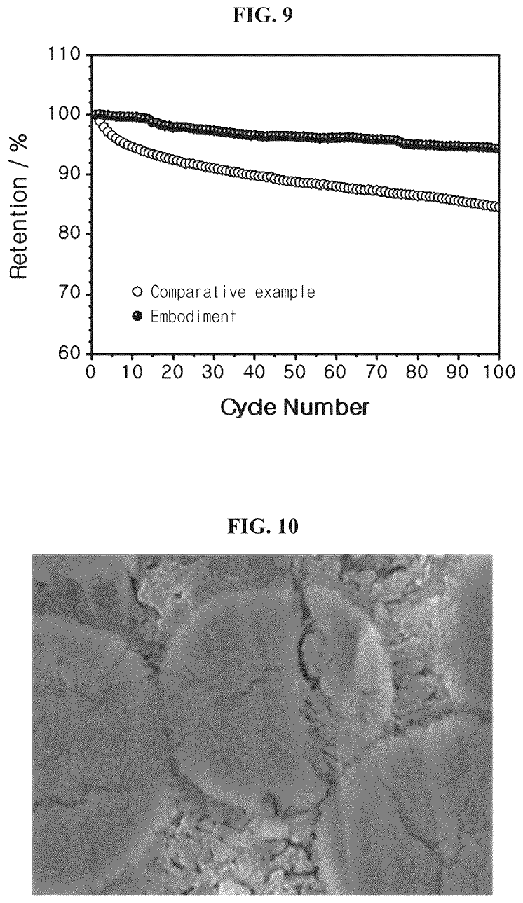

The life characteristic evaluation was conducted under the conditions of 30° C. and 0.2 C, and the evaluation results are as shown in FIG. 9. FIG. 9 is a graph showing the results of life characteristic evaluation of all-solid-state batteries according to an embodiment and a first comparative example.

Referring to FIG. 9, it can be confirmed that the life characteristic is better in the embodiment than in the first comparative example. That is, it can be seen that the life retention rate after 100 cycles is 94.4% in the all-solid-state battery including the positive electrode active material according to the embodiment, which is superior to 84.6% in case of the first comparative example.

In case of the nickel-rich NCM positive electrode active material, such as the positive electrode active material used in the embodiment and the comparative example, particle crack may occur due to stress caused by volume change of the positive electrode active material that occurs during repeated charging and discharging as the life progresses.

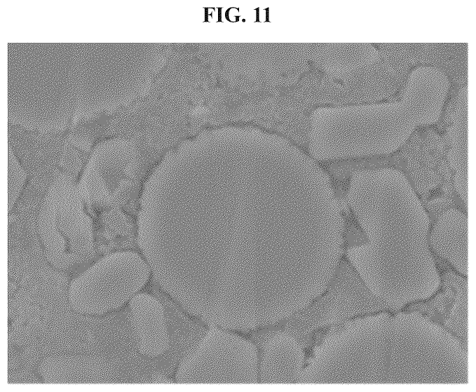

In order to observe the particle crack phenomenon of the positive electrode active material after the life evaluation, a cross-sectional SEM measurement of the positive electrode was performed after the life evaluation, and the SEM images are as shown in FIGS. 10 and 11. FIG. 10 is an SEM image showing the cross-section of a positive electrode according to a first comparative example after the life characteristic evaluation of FIG. 9, and FIG. 11 is an SEM image showing the cross-section of a positive electrode according to an embodiment after the life characteristic evaluation of FIG. 9.

Referring to FIGS. 10 and 11, it can be confirmed that after 100-cycle life evaluation, a particle crack phenomenon of the large-particle positive electrode active material significantly occurred in the first comparative example.

On the other hand, it can be confirmed that in case of the positive electrode active material having a bimodal particle-size distribution according to the embodiment, the particle crack phenomenon was suppressed in both the large- and small-particle positive electrode active materials. Here, suppressing the particle crack does not mean completely blocking the particle crack, but significantly reducing the occurrence of particle crack.

It can be seen that the main cause of the deterioration of the lifespan in the first comparative example is due to the interruption of the conduction path caused by particle crack of the positive electrode active material. On the other hand, it can be seen that the embodiment in which particle crack of the positive electrode active material is suppressed even as the lifespan progresses can secure excellent lifespan characteristics.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A positive electrode for an all-solid-state battery, comprising:
a positive electrode active material comprising a lithium transition metal oxide and having a multimodal particle-size distribution in which particles with relatively small particle diameters have greater particle strength than particles with relatively large particle diameters.

2. The positive electrode of claim 1, wherein the positive electrode active material has the multimodal particle-size distribution with different average particle diameters of D₅₀ values.

3. The positive electrode of claim 1, wherein the positive electrode active material has the multimodal particle-size distribution in which there are a large-particle positive electrode active material (A) and a small-particle positive electrode active material (B) having different average particle diameters of D₅₀ values, and
wherein a particle strength ratio is dB/dA≥2, where dA is the particle strength of the large-particle positive electrode active material, and dB is the particle strength of the small-particle positive electrode active material.

4. The positive electrode of claim 3, wherein a particle diameter ratio of the large-particle positive electrode active material to the small-particle positive electrode active material is rA/rB≥2, where rA is the particle diameter of the large-particle positive electrode active material, and rB is the particle diameter of the small-particle positive electrode active material.

5. The positive electrode of claim 3, wherein each SPAN value of the large-particle positive electrode active material and the small-particle positive electrode active material is (D₉₀−D₁₀)/D₅₀<1, and wherein the SPAN value refers to a width of the multimodal particle-size distribution calculated using values of particle diameters D₁₀, D₅₀, and D₉₀.

6. The positive electrode of claim 3, wherein the small-particle positive electrode active material has a particle strength of 300 MPa to 1500 MPa.

7. The positive electrode of claim 3, wherein a weight ratio of the large-particle positive electrode active material to the small-particle positive electrode active material is 7:3 to 4:6.

8. The positive electrode of claim 3, wherein the large-particle positive electrode active material comprises a secondary particle in which primary particles are aggregated, and wherein the small-particle positive electrode active material comprises a single particle.

9. The positive electrode of claim 3, wherein each of the large-particle positive electrode active material and the small-particle positive electrode active material comprises a secondary particle in which primary particles are aggregated.

10. The positive electrode of claim 1, wherein the lithium transition metal oxide is represented by Chemical Formula below:
LiₓM_{y}O₂ Chemical Formula
where M contains Ni and further contains at least one selected from Co, Mn, Al, Fe, V, Zn, Cr, Ti, Ta, Mg, Mo, Zr, W, Sn, Hf, Nd, and Gd, 0<x≤1.5, and 0<y≤1.

11. The positive electrode of claim 10, wherein the lithium transition metal oxide includes at least one of NCA, NCM, or NCMA having a layered structure with a Ni content of 60% or more.

12. The positive electrode of claim 1, further comprising:
a solid electrolyte;
a conductive agent; and
a binder.

13. The positive electrode of claim 12, wherein a weight ratio of the positive electrode active material to the solid electrolyte is 85% or more.

14. An all-solid-state battery comprising:
a positive electrode;
a solid electrolyte layer, and
a negative electrode,
wherein the positive electrode contains a positive electrode active material comprising a lithium transition metal oxide and having a multimodal particle-size distribution in which particles with relatively small particle diameters have greater particle strength than particles with relatively large particle diameters.
